(19) United States
(12) Patent Application Publication
(10) Pub. No.: US 2006/0169530 A1
(43) Pub. Date: Aug. 3, 2006

(54) Loudspeaker enclosure element for forming vertical line array systems with adjustable horizontal and vertical directivity

(76) Inventors: Guido Noselli, Flero (Brescia) (IT); Stefano Noselli, Flero (Brescia) (IT); Michele Noselli, Flero (Brescia) (IT)

Correspondence Address: MCGLEW & TUTTLE, PC, P.O. BOX 9227, SCARBOROUGH STATION, SCARBOROUGH, NY, 10510-9227, US

(21) Appl. No.: 11/099,194

(22) Filed: Apr. 5, 2005

(30) Foreign Application Priority Data
Jan. 28, 2005 (IT) BS 2005 A 00006

(51) Int. Cl. G10K 11/00

(52) U.S. Cl. 181/187; 181/191

(57) ABSTRACT

A sound reinforcement system is disclosed for the reproduction of wide-range high-power sound, which comprises several loudspeaker enclosures, each containing at least one driver or loudspeaker with an emission throat, a duct with parallel or inclined walls between the emission throat of the driver or loudspeaker and a diffraction slot, and a wave guide that continues from the diffraction throat onwards, consisting in divergent walls, of which the inclination of at least one can be varied. Each loudspeaker enclosure element is equipped with mechanical parts on each side, for its connection to other identical enclosure elements, positioned vertically one above another and horizontally alongside one another, for a variation of the inclination of each enclosure element on the vertical plane, regulation of the wave guide aperture on the horizontal plan and regulation of vertical and horizontal sound dispersion.

### FIELD OF INVENTION

This invention generally belongs to the wide-range high-power sound reinforcement field and proposes, in particular, improved modular loudspeaker enclosures, normally usable as single elements with horizontal and vertical directivity adjustment, which can be installed vertically one above another to form so-called Line Arrays whose directivity also can be adjusted both horizontally and vertically, or can also be further connected to form so-called Point Source Arrays, starting in both cases with single loudspeaker enclosures or enclosures previously assembled in multiples.

### PRIOR ART

After Heil, in the wide-range high-power sound reinforcement field, the operating principles above all at high frequencies of loudspeaker enclosure systems forming Vertical Line Arrays became better known. With these, using a certain number of loudspeaker enclosure elements, positioned one above another and reciprocally inclined with appropriate mechanical systems, as well as being connected and/or adjusted electrically, it is possible to achieve a pronounced directivity on the vertical plane for a wide range of frequencies, which depends on the dimensions of the individual elements and the combination of all the elements, in order to project sound with a high power level to relatively distant areas, according to the distribution of the audience, as is desirable and necessary in professional sound reinforcement work.

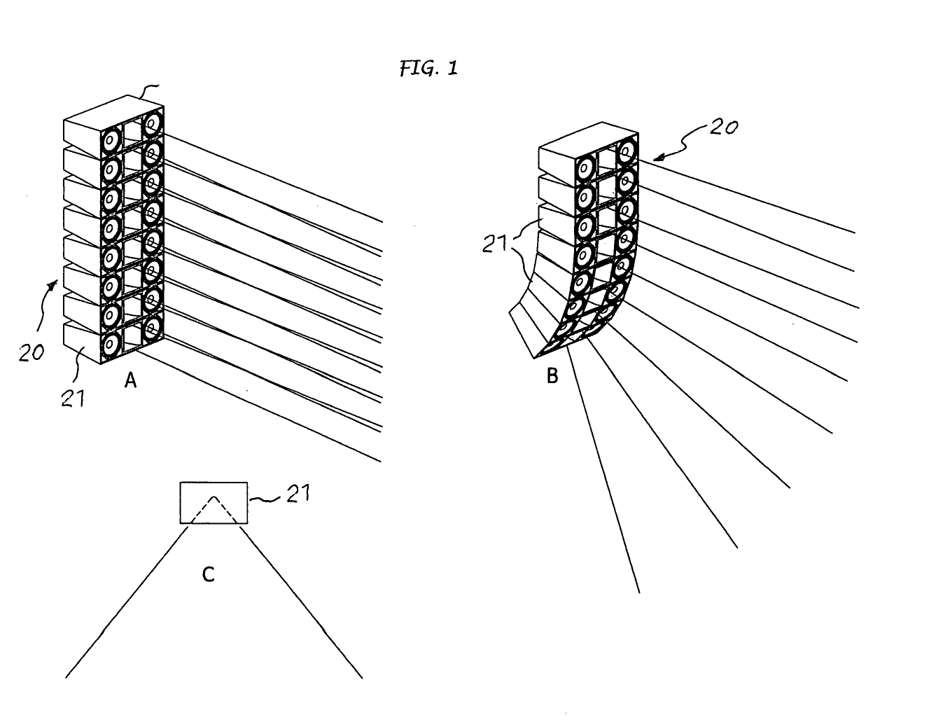

FIGS. 1A, B and C of the enclosed drawings show various views of a typical current Vertical Line Array (20). This consists in complete enclosures (21) hinged together for regulation of the vertical inclination, having a fixed dispersion on the horizontal plane and a dispersion on the vertical plane derived from the sum of the aperture (splay) angles between the elements. The dispersion and dimension of each individual element is such that there is acoustic coupling up to the mid frequencies. For higher frequencies, there is emission overlap, with more interference in the case of a straight array—FIG. 1A—(which moreover has few or no practical applications). For small aperture between elements, gradually increasing in such a way as to obtain the required total vertical coverage angle, there is in fact no interference due to emission overlap—FIG. 1B—, as the mid-high frequency wave guide is much more directive than traditional loudspeakers conceived for coupling in so-called Point Source Array clusters. The entire system's horizontal dispersion is fixed—FIG. 1C.

The increased advantages that positioning loudspeaker enclosures in Vertical Line Arrays gives in terms of sound level on the emission axis and in terms of complete, or almost, control of the directivity on the vertical plane are now equally well known. This is thanks also to the pre-processing of the sound program, as far as both time and frequency dominions are concerned, which has recently become possible by using DSP (Data Signal Processing).

The setting of the vertical directivity with Vertical Line Arrays enables precise sound coverage to be achieved, mainly due to the dimension of the individual elements connected in multiples with other identical units. Nevertheless, this does not generally foresee the possibility of obtaining from systems formed in this way such precise directivity on the horizontal plane, apart from that of the individual loudspeaker elements (FIG. 1C).

In other words, the horizontal directivity of a Vertical Line Array is the same as that of a single element. At present, it can be regulated or in some way “adjusted”, as is the case when several loudspeakers are positioned alongside one another horizontally in so-called Point Source Array systems, with the same, if not more serious, problems of emission overlap, and therefore comb filtering between the loudspeaker enclosures, more or less pronounced according to the splay angles chosen to obtain the best sound coverage of the audience.

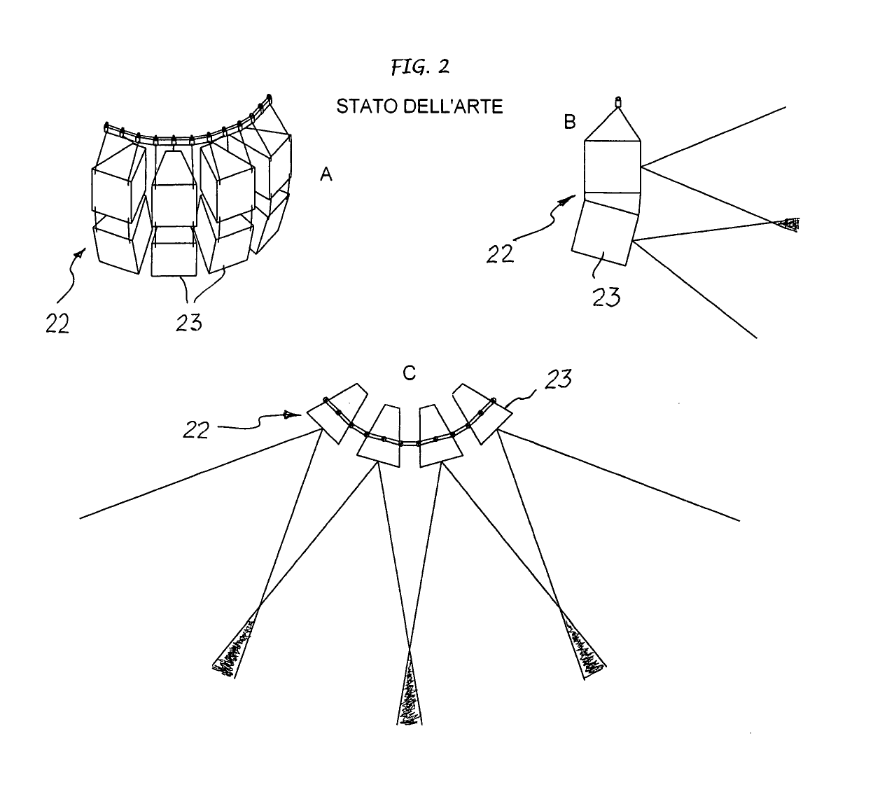

FIGS. 2A, B and C of the drawings show the same number of views of an example of a Point Source Array (22), which clearly illustrate the interference immediately created on both the horizontal and vertical planes, due to the emission overlaps, which do not follow the angle deriving from the rake of each enclosure (23), apart from the case in which this angle coincides with the loudspeaker enclosure's dispersion angle. This event is very rare and cannot occur for compact enclosures, as the rake necessary for coupling these enclosures, which, precisely due to their dimensions, have a very wide dispersion (the smaller the enclosure, the closer its dispersion is to theoretical “Point Source” dispersion), would be so pronounced as to greatly reduce the depth of the rear of the enclosure, to the extent that the volume necessary for the acoustic loading of the loudspeakers would not be obtained, or even that the latter could not be contained in the small volume at their disposal.

This large amount of interference, typical of Point Source Arrays, is essentially due to the fact that, precisely due to this positioning, the physical and geometrical structure of each single loudspeaker enclosure element, which in a Vertical Line Array are conceived precisely for the best vertical coupling, as free as possible from reciprocal interference between the individual loudspeakers contained in it, do not take at all into consideration the destructive acoustic interference caused by the diffraction phenomena linked with the frequencies whose wavelength is similar to or greater than the horizontal dimension of the single element, interference that occurs when two or more single elements are positioned side by side to increase horizontal dispersion.

In other words, since the horizontal dimension is generally not less than two times greater than the vertical dimension, the difficult positioning of several Vertical Line Arrays side by side on the horizontal plane produces negative (even depreciatory) effects compared to those produced in Point Source Arrays.

This poor audio quality is also caused, and not to a lesser extent, by characteristics of a mechanical and geometrical nature, which prevent suitable close positioning and flying or stacking of two Vertical Line Arrays previously curved downwards to achieve the best sound coverage, both for near field coverage, immediately under the Line Array, and for long throws, where the system must project high-level sound.

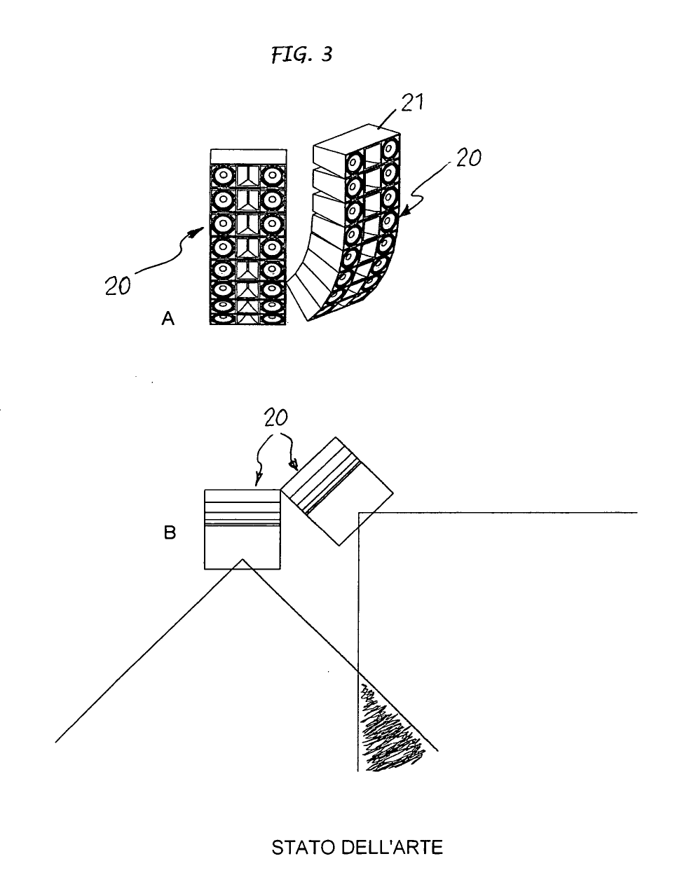

FIGS. 3A and B show a schematic example of positioning Vertical Line Arrays (20) alongside one another, according to the current usage, in which nevertheless the two Line Arrays are not positioned in such a way as to obtain the best possible acoustic coupling and minimization of horizontal interference due to the “J” curve. In fact, they are seen to be close at the bottom and far apart at the upper part of the array, so on one hand there is an acoustic coupling of the same type as found in Point Source Arrays, with harmful interference on the horizontal plane, due to the overlap of the sound emission and the consequent comb filtering, and on the other there's the addition of the aggravating circumstance that this very poor coupling is also variable as far as frequency is concerned, as the distances between the elements are differentiated because of the shape of the array, which changes every time, according to the necessary vertical coverage angle; without forgetting that there are more difficult geometrical/mechanical conditions with reference to the flying of two or more systems side by side.

### AIMS OF THE INVENTION

This invention's primary aim is to provide a modular loudspeaker, with horizontal and vertical adjustable directivity, to be used normally alone but also to overcome the aforementioned limits, which favour the use of a Vertical Line Array configuration in “long throw” professional sound reinforcement systems, in situations in which the audience is distributed above all depth-wise and which, on the other hand, make their use complicated and costly when it is necessary to cover an audience distributed width-wise and only to a limited extent depth-wise.

To meet this last need, it is normally necessary to adopt additional Vertical Line Array systems flown or stacked alongside the main systems, generally positioned at the side of the stage front, doubling or in any case considerably increasing the number of enclosures and therefore overall costs, with the aim of achieving adequate audience coverage, above all over short and medium distances, where the horizontal dispersion of only the front systems is not sufficiently wide to cover the audience, also having to be subject to the aforementioned quality drawbacks.

In fact, the majority of the models on the market have a dispersion on the horizontal plane that is does not exceed 90° at −6 dB in the mid range, while in the high range it is often even lower. Then, when a model is found with wider horizontal dispersion, for example 120°, this enclosure is not built so much for use as an element of the main Vertical Line Array, which has the job of projecting the sound over a long distance, but rather as an auxiliary element for reinforcing the sound program close to the stage or at least forming Vertical Line Arrays only suited to projecting sound over short distances.

This is a contradiction however, because, if the aim is precisely that of projecting sound over short distances with a wide dispersion angle, it may be more favourable and less costly to use traditional Point Source Array systems (FIG. 2).

One object of this invention on the other hand is to propose and realize a sound reinforcement system which combines the acoustic advantages of both configurations, i.e. the Vertical Line Arrays and Point Source Arrays, without maintaining the disadvantages of each, and adding new and more effective functions from the point of view of the ease with which they can be adapted to use for widely varied types of sound reinforcement.

Another object of the invention is to provide a sound reinforcement system in Vertical Line Array configuration, made up of single loudspeaker enclosures or enclosures preassembled in multiples, which can be angularly positioned in relation to one another to regulate sound emission directivity on both the vertical and horizontal plane.

These objects are achieved with a sound reinforcement system consisting in several loudspeaker enclosure elements, each containing at least one driver or loudspeaker with an emission hole or throat, a duct with parallel or inclined walls between the emission throat and a diffraction slot, a wave guide that runs from the diffraction throat onwards, consisting in divergent walls, at least one of which has an adjustable angle, and characterized by the fact that each enclosure element is equipped with mechanical parts on each side for its connection with other identical enclosures, positioned vertically one above another or horizontally along side one another, for a variation of the inclination of each enclosure element on the vertical plane and a regulation of the wave guide aperture on the horizontal plane.

### BRIEF DESCRIPTION OF THE DESIGNS

Greater details of the invention will be clear from the later description and enclosed drawings, which are illustrative but not limiting, and in which:

FIGS. 1, 2 and 3 are indicative of the above described prior art, regarding Vertical Line Arrays and Point Source Arrays;

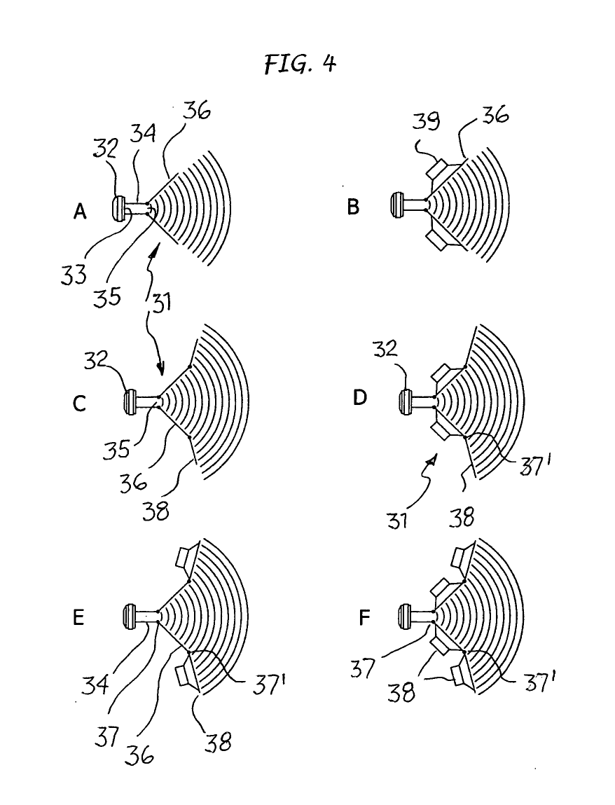

FIG. 4A to F show a schematic view from above of some examples that show the positioning and regulation of sound emission directivity according to the invention;

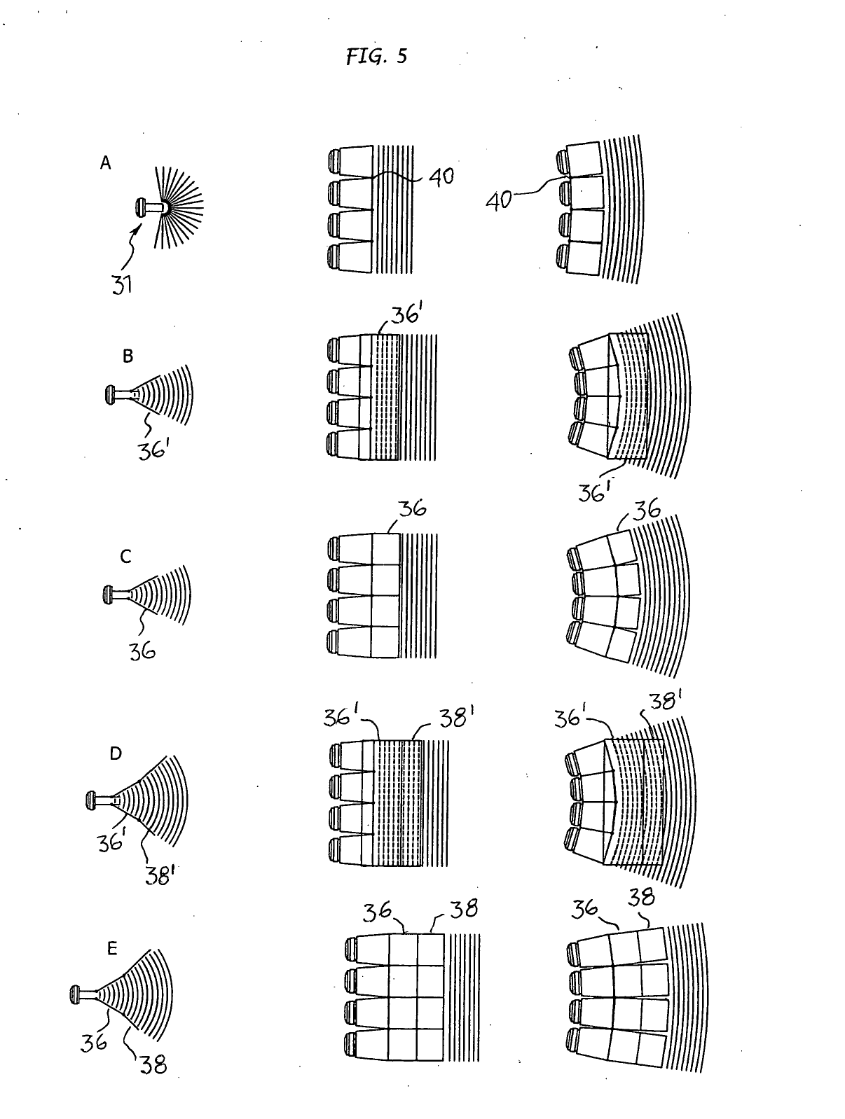

FIG. 5A to E show examples of regulation of the dispersion on the vertical plane regarding some illustrations in FIG. 4;

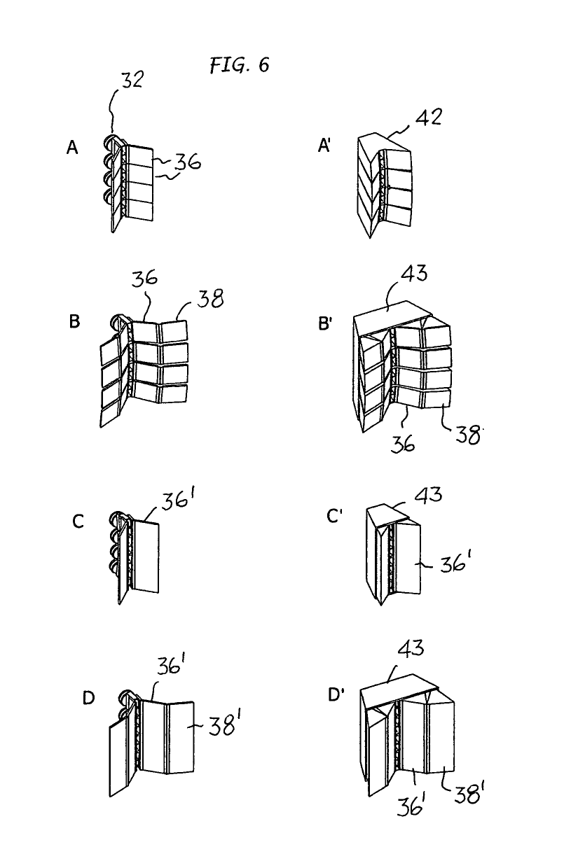

FIGS. 6A-D and A′-D′ show some schematic examples of Vertical Line Arrays comprising separate elements one above another, mounted individually in their own boxes, or together in a single box and equipped individually or together with walls for the wave guide:

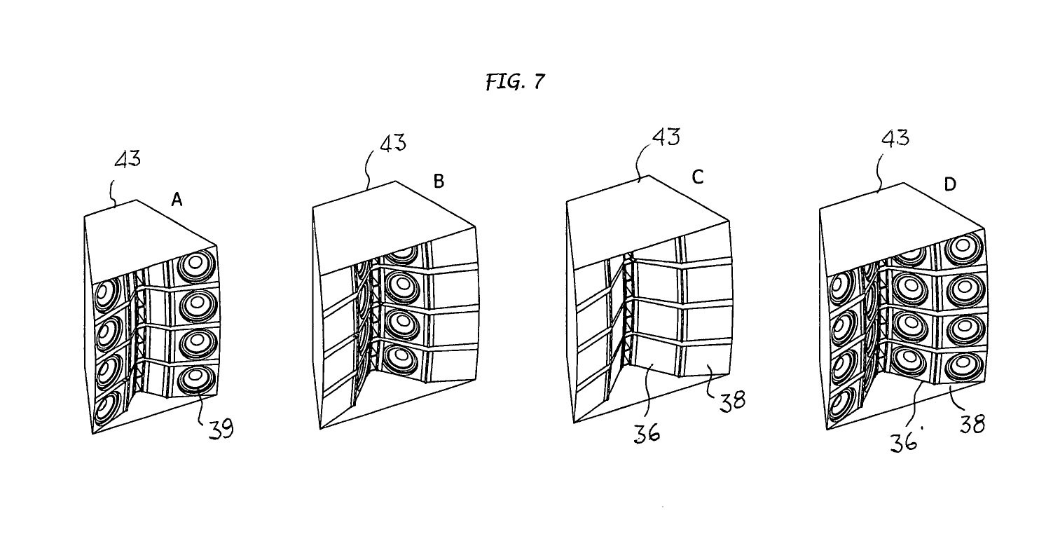

FIG. 7A to D show the examples of fitting single elements in compact boxes;

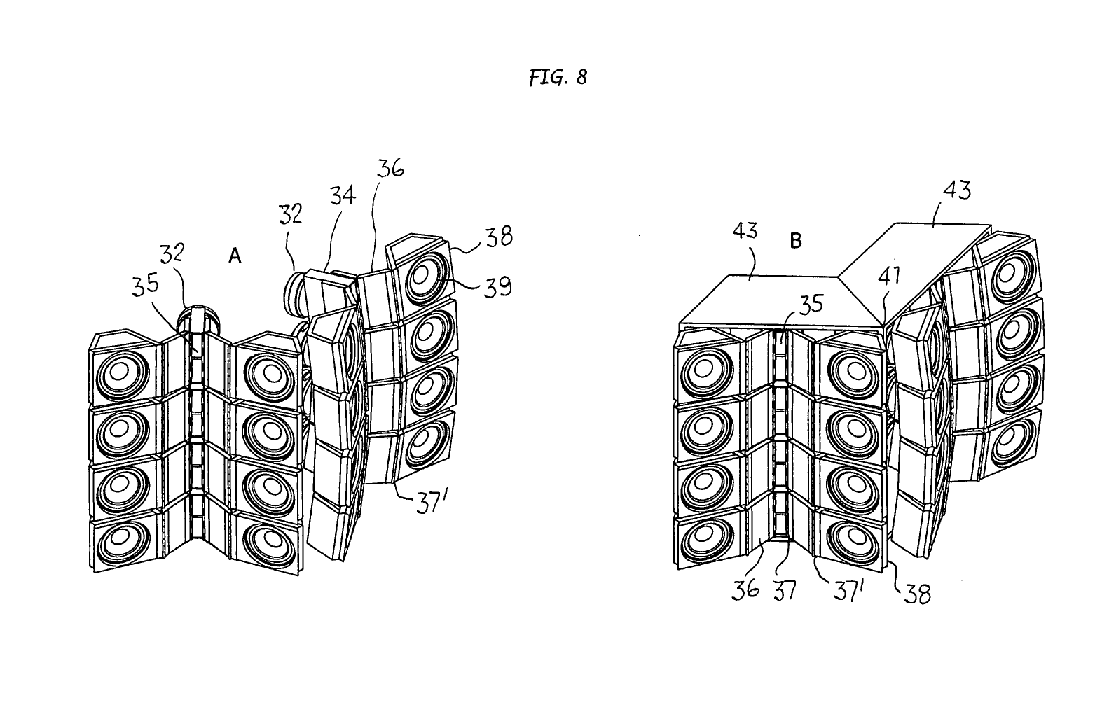

FIG. 8A, B show two examples of horizontal coupling of single elements, respectively with or without boxes;

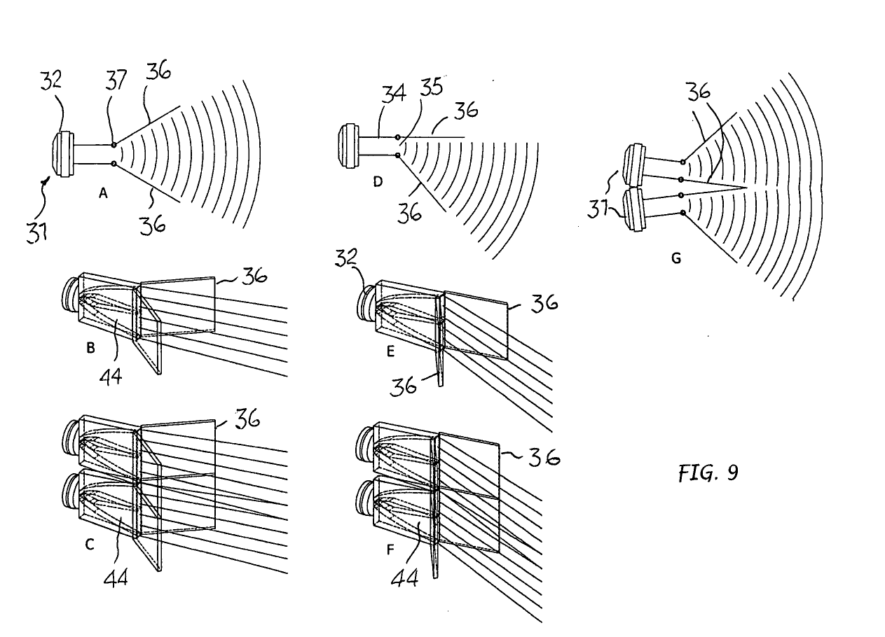

FIG. 9A to G show the same number of examples of the layout of the components and possible regulations of directivity in different coupling set-ups;

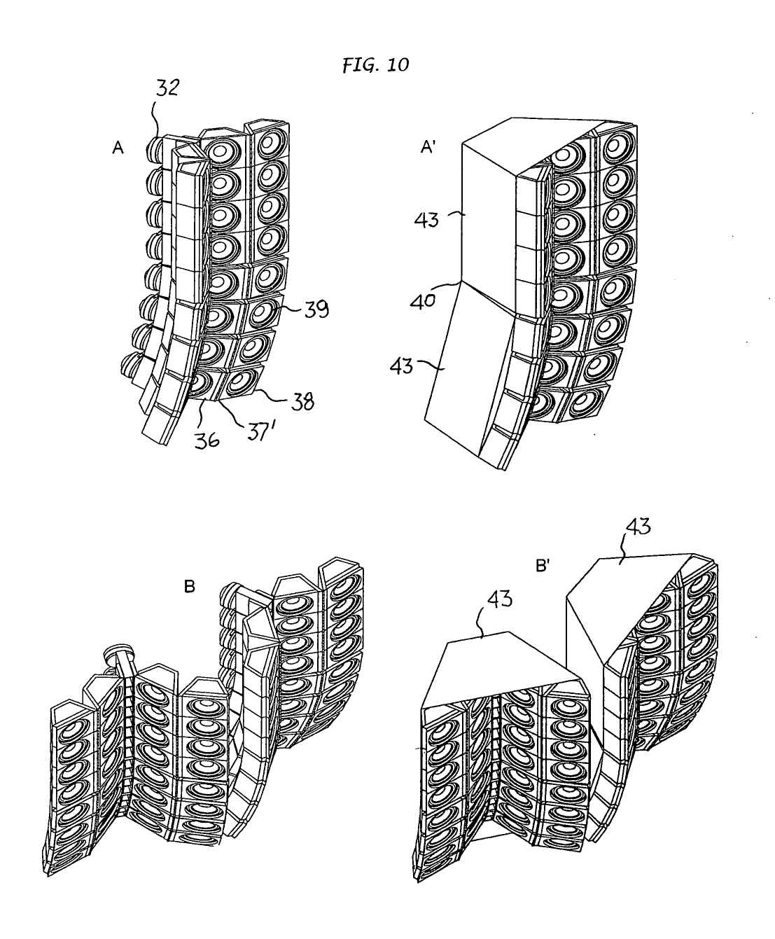

FIGS. 10A-A′ and B-B′ show some examples of systems with multiple elements one above another and alongside one another as Vertical Line Arrays without and with boxes, respectively;

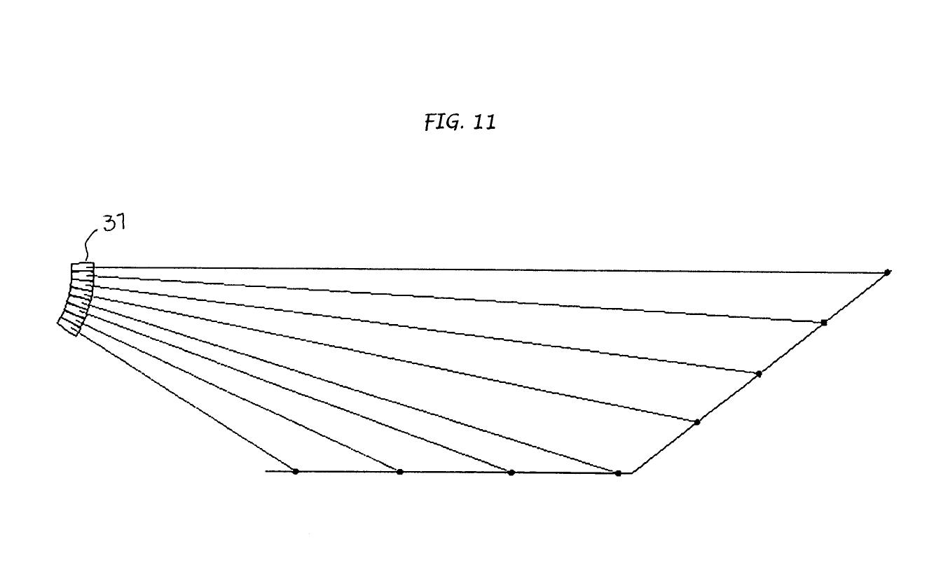

FIG. 11 is a diagram showing the aiming at the audience of the axes of several loudspeakers in a Vertical Line Array;

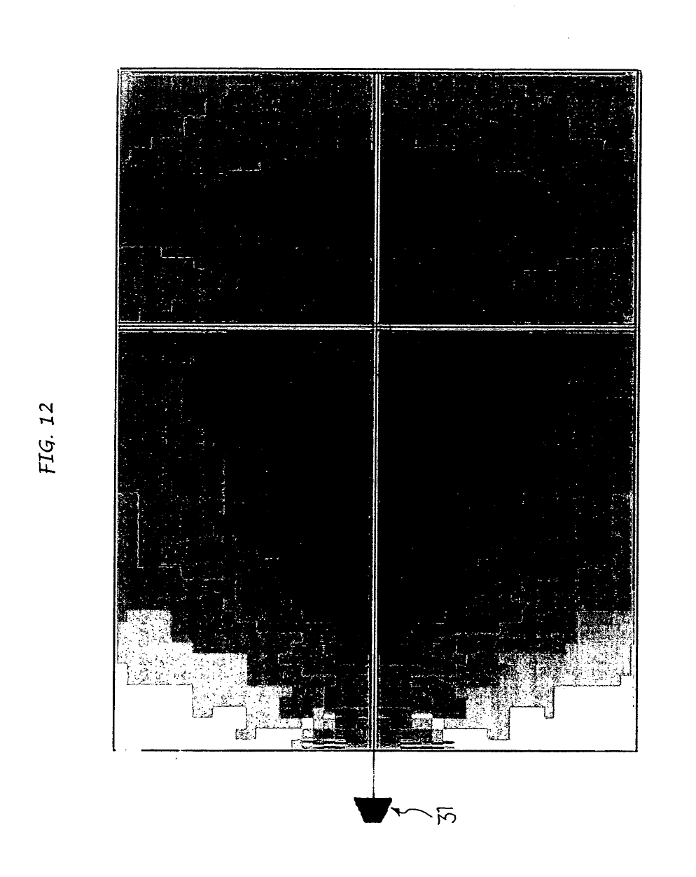

FIG. 12 shows the distribution of the sound pressure of a Vertical Line Array according to FIG. 11; and

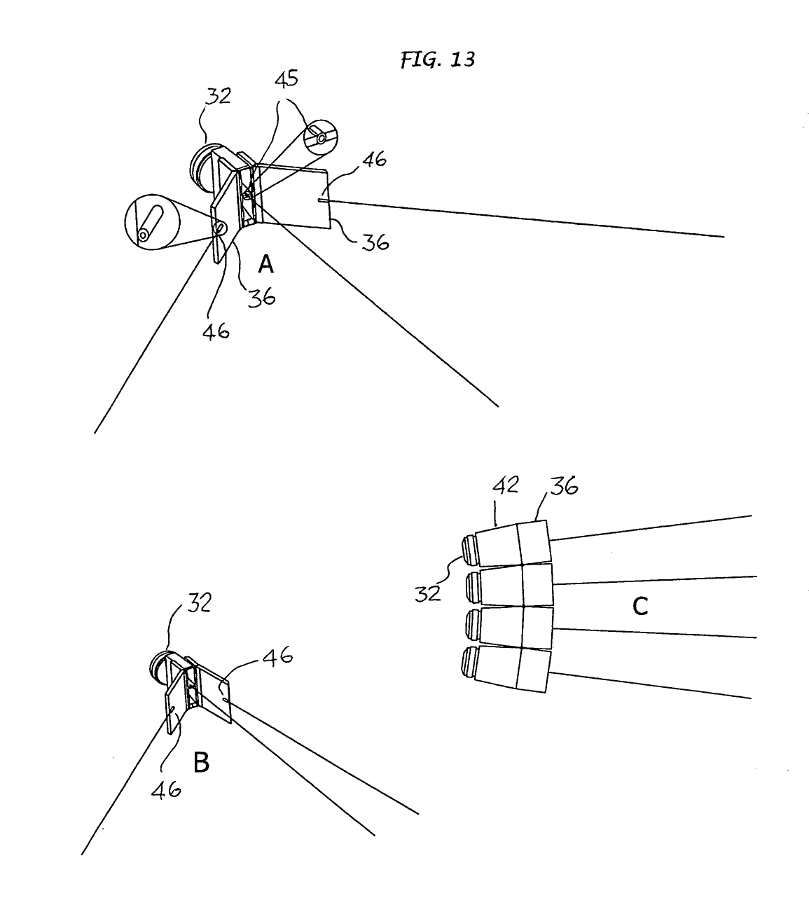

FIG. 13 shows a laser aiming system to emphasize the directivity of each loudspeaker enclosure element.

### DETAILED DESCRIPTION OF THE INVENTION

The characteristic aspect of the invention consists substantially in the vertical and horizontal coupling of loudspeaker enclosure elements (31) built with geometrical and dimension features suited not to the ideal layout for Vertical Line Arrays, but also regarding the horizontal coupling of several Vertical Line Arrays, thanks to the innovative peculiarity incorporated in each single element, stand alone usable, of the regulation of both its vertical and horizontal dispersion.

Each loudspeaker enclosure element (31) in a basic configuration as shown in FIG. 4, includes at least one active element, such as a compression driver (32) or a loudspeaker, with a sound emission throat (33) followed by a duct (34), whose sides can be parallel or inclined, and ends with a diffraction slot (35).

From the sides of the diffraction slot onwards, there are two vertical walls (36), which control sound emission, forming a so-called wave guide. At least one, or even better both, of the walls (36) are hinged (37) in order that its/their inclination can be varied both symmetrically and asymmetrically, subsequently modifying the aperture and orientation of the wave guide, and therefore the directivity of sound emission on the horizontal plane.

Continuing the walls (36) of the wave guide, other additional wall sections (38) can be provided, which are also hinged (37) in order that their inclination can be adjusted as required, again with a view to varying sound emission directivity.

On the walls (36) and/or additional wall portions (38) other active components, such as loudspeakers (39), can be applied facing the wave guide and able to be positioned with the wall itself, with the aim of increasing the power of the emitted sound and, due to the interference created between the loudspeakers mounted on the aforementioned adjacent walls, also control the horizontal directivity of the lowest frequencies not reproduced by the compression driver.

Each loudspeaker enclosure element (31) thus configured can be vertically combined with other identical elements, as shown in FIG. 5 and 6, coupling them by means of horizontal hinges (40) in order to adjust their angle and therefore the dispersion of the sound on the vertical plane in addition to the adjustment of the directivity on the horizontal plane, carried out thanks to the variability of the wave guide's aperture and orientation. The hinges (40) connecting loudspeakers one above another will preferably be on the emission plane of the diffraction throats (35) to maintain the latter's continuity in any condition of inclination of the loudspeaker enclosure elements.

Each loudspeaker enclosure element (31) can also be equipped for vertical axis connection (41) alongside other loudspeaker enclosure elements, as in FIG. 8B, thus creating a multiple loudspeaker enclosure system whose dispersion is adjustable both vertically and horizontally.

Each loudspeaker enclosure element (31) can also be fitted in its own box (42) and coupled vertically with other identical elements, hinging the boxes (42) of the individual elements—FIG. 6A′. Or several loudspeaker enclosure elements (31) can be positioned one above another and all mounted in a single box (43), which can be connected to other boxes above and alongside, each containing several loudspeaker enclosures, as shown in FIG. 6B′, C′, D′, in FIG. 7 and in FIG. 8B, also retaining the possibility of separate adjustment of the enclosures and simplifying from the point of view of mounting the formation of larger Vertical Line Arrays—FIG. 10.

The boxes for individual loudspeaker enclosures (42) and for multiple loudspeakers enclosures one above another (43) are raked toward the rear, as far as both height and width are concerned, to allow their angle to be varied when coupled with other identical boxes of loudspeaker enclosures.

In each form of set-up, the walls that can be orientated horizontally (36, 38) defining the wave guide, with or without auxiliary active elements, can be associated with and connected to each single loudspeaker enclosure, as shown in FIGS. 6A and B. Moveable walls (36′, 38′) of the wave guide can also be foreseen for use with several loudspeaker enclosure elements one above another and therefore with an extension equal to the height of the group of loudspeaker elements one above another as shown in FIGS. 5B and D and in FIGS. 6C, D and C′, D′.

This invention therefore overcomes the inborn limit, not only of the standard loudspeakers system used alone, but of current Vertical Line Arrays, because on one hand it allows the coupling and regulation of the angle with other multiple elements on the vertical plane, respecting all the geometric and physical conditions at the basis of the acoustic operation of such a configuration, and on the other hand allows simultaneous regulation of the horizontal dispersion angle of each single element or of several elements previously positioned one above another and adjustable in relation to each other, even contained in separate boxes, which in turn can be coupled and adjusted in the same way as the single elements.

This original feature of the elements built mainly, but not exclusively, for use in Vertical Line Arrays, also allow to form so-called Point Source Arrays in turn made up of several Vertical Line Arrays without serious compromises or insurmountable difficulties (FIG. 10).

The boxes in which the basic elements, individually or in multiples of two or more, are integrated themselves become enclosures, whose vertical and horizontal directivity can be adjusted, and can also be used like single traditional enclosures, which are compact as far as their footprint is concerned, but more practical, thanks precisely to the fact that their dispersion is adjustable within wide limits to suit the audience.

The fact that the sound reinforcement systems according to the invention, with directivity that is adjustable on both the vertical and horizontal plane, are innovative can also be appreciated by a comparison with other systems disclosed in certain patent publications, in which the problem of directivity adjustment was faced and solved partially and in some cases in a manner that seems self-defeating from the point of view of the acoustic results achieved.

For example, in U.S. Pat. No. 4,165,797 a method is disclosed for adjusting the directivity of an enclosure that includes at least four loudspeakers mounted on four separate square panels, which are in turn mounted, frontally coupled, in a single box in such a way that they can move from the centre outwards in the direction of the sound's propagation, adjusted by means of a screw control that affects all four adjacent angles simultaneously, one for each of the panels, being individually hinged at their opposite outer angles. As far as only high or very high frequencies are concerned, this system allows to widen or narrow frontal dispersion in a symmetric manner, and not separately for the two (horizontal and vertical) listening planes.

Document U.S. Pat. No. 4,194,590 discloses a method that is even more limited than the previous one, for adjusting only the horizontal directivity of a horn in two different angles (60° and 120°), by means of a variation of the path of the sound (presumably emitted by a compression driver) that travels along a tube that can be rotated from outside with a knob, in order that the side openings, appropriately positioned on the tube itself, communicate, according to the position of the knob, alternatively with a first or second expansion of the horn.

The first defined by the internal walls forming a dispersion angle of 60° on the horizontal plane. The second defined by the outer walls, forming a dispersion angle of 120°.

This device does not allow to vary directivity on both (horizontal and vertical) planes either and, moreover, the sole variation of horizontal directivity is not based on regulation of the aperture of the walls of the horn or wave guide that sets the horizontal dispersion, as in this invention: neither is it possible to regulate the splay angle between single elements coupled to form a Vertical Line Array.

On the other hand, to vary the directivity, only on the horizontal plane, document U.S. Pat. No. 5,590,214 discloses the use of the method of the reciprocal inclination of the walls forming the horn or wave guide.

In it, the variation of the aperture angle is foreseen not only for the walls setting the dispersion, but also for the walls on which the active components or loudspeakers which one presumes also (or only) reproduce the high frequencies are mounted, facing each other in various types and quantities; this implies a variation of the dimension of the throat or diffraction slot with consequent unforeseeable variations of the acoustic loading for both the active component upstream (the driver) and the horn or wave guide itself downstream of the diffraction slot.

This version does not foresee any variation of vertical dispersion simultaneously to the variation of horizontal dispersion.

Moreover, it differs greatly from this invention as far as acoustic operation is concerned, since it implies the variation of the aperture of the diffraction slot at the beginning of the throat of the actual wave guide or horn.

This variation makes the frequency response uncontrollable: it undergoes alterations that cannot be overlooked, according to the horizontal dimension assumed on each occasion by the slot.

It also differs in the position of the components, which are shown in this document mounted inside a triangular-shaped cavity, with a volume that varies according to the aperture of the diffraction slot; the components are mounted facing out and opposite each other, and in some variations aligned vertically, when there is more than one, in a fixed position, and at the same time coupled depth-wise, even with different types, in the direction of the sound's propagation. This last position is generally detrimental for the quality of the sound emerging from the slot, due to the different length of each component's sound path from the respective acoustic centre to the throat of the diffraction slot itself.

The system in this invention on the other hand operates in a completely different manner from an acoustic and mechanical point of view. In fact, the active component, i.e. the compression driver (32), or flat diaphragm loudspeaker (or dome speaker in the case of a wave guide for high frequencies or (not exclusively for high frequencies) a concave diaphragm loudspeaker, is mounted at the opposite end of the actual wave guide or horn, having two or more walls that can be adjusted independently from each other, facing on to a duct with fixed walls that finish in the diffraction throat with fixed dimensions at the beginning of the wave guide with adjustable walls, which themselves set the horizontal dispersion angle—FIG. 9A, D, G.

Moreover, a phasing device (44) can be mounted in the duct (34), or the duct itself can be built in such as way as to make the two paths from the emission throat (33), where the active component is fitted, to the following diffraction slot (35) equal, in order to eliminate interference due to the difference in arrival time of the sound at the throat itself—FIGS. 9B, C, E and F.

This type of design does not lead to any variation of the acoustic loading considered from the active component and at the throat of the wave guide or horn positioned after; therefore the characteristics of the sound in relation to the frequency are not varied, because the volume of the load remains unchanged, as does the dimension of the throat or diffraction slot from which the sound emerges to be directed by the adjustable walls.

Then, the invention enables to adjust the vertical aperture angle, which occurs between to loudspeaker elements, simultaneously to the adjustment of the horizontal aperture angle of the walls that are in front of the diffraction throat/slot (35), which can also be carried out asymmetrically, for each single element and for each box previously formed by connected single elements, obtaining dispersion angles that combine according to the geometric angles with which it's possible to mechanically position the elements themselves alongside one another.

The invention therefore allows the (previously unknown) regulation of the directivity of a sound reinforcement system based on the use of Vertical Line Arrays, whose dispersion can also be varied on the horizontal plane. Users will thus have at their disposal a system that can be adapted to suit any possible situation, according to the audience to be covered.

Using a system built according to the invention raises a problem for users: deciding, with sufficient precision, with which vertical and horizontal aperture angles the system should be used to meet audience sound coverage needs.

At present, to solve the problem in the case of just the vertical regulation, all Vertical Line Array manufacturers tend to provide users a virtual aiming software program for the array's single elements.

The software graphically simulates the aperture of the angles between the elements positioned one above another, then graphically shows the direction taken by the emission axes of each single element, which intercepts the various listening planes that the software enables to be designed with e series of simple lines, enabling the areas they define to be seen—FIG. 11.

In more sophisticated cases, these software programs are complete with functions not only of a mechanical or geometric nature, but also of an acoustic nature, such as for example plotting, by means of the use of colours or gray scale, the simulated sound pressure on the listening areas designed, viewed from above and intercepted by the emission axes of each single element of the Vertical Line Array—FIG. 12.

Although extremely useful, this method does not always satisfy the practical needs of those who use these sound reinforcement systems frequently, as is the case of tour applications, with numerous shows held day after day, each in a different location. In fact, in these cases, there is not sufficient time to use the software described profitably, since this work, if done in a complete exhaustive manner, requires numerous simulations to find the most suitable loudspeaker enclosure set-up for the area to be covered, which changes for each show, and considerable time is required to check the virtual results required, unless one is satisfied with the first one obtained.

To solve this problem too, the method for regulating the aperture of the angles of the elements has been integrated with an optical system to view the coverage of the audience in real time, in a simple effective manner.

The method consists in the application of several laser emitters on each individual Vertical Line Array element: a first central laser (45) that emits light from the acoustic centre or sound emission axis, and other laser emitters (46) fixed to the walls of the wave guide or horn, whose aperture or closure sets the horizontal dispersion—FIG. 13.

The simultaneous visualization of the ray of light emitted by the centre laser, corresponding to the aiming axis for each individual element, and the beams emitted by the other lasers, preferably of a different colour from that of the light emitted by the first, which lead from the wall of the wave guide or horn, defining the horizontal dispersion angle and enabling to pick out with great precision the area covered by the individual element and therefore by the group of elements, in order to adjust the reciprocal angles (splay) in real time, for the best results with minimum emission overlap and thus less harmful interference.

In other words, the regulation of the inclination of the enclosures, which can be done manually, or even mechanically by using small electric motors moving appropriate mechanical parts, is seen in the result to indicate clearly and in real time the solid (vertical and horizontal) sound coverage angle, defined by the light emitted simultaneously by the above-mentioned lasers.

This method is a great advantage for the rapidity with which the system can be regulated compared to the area to be covered, also and above all, when the time available for carrying out this work before the show is very limited. It also appears as an improvement to that described in the publication US 2001/0029675, where just one laser emitter is used, fitted to the baffle of a traditional loudspeaker enclosure that has no device for adjusting directivity. This laser generates a horizontal line that can to some extent (only on the horizontal plane) show sound coverage, but gives no indication of vertical sound coverage, which is also particularly important and necessary in live show applications, if one considers the large vertical dispersion required in arenas and in public show venues such as theatres and auditoria.

1. A Sound reinforcement system for the reproduction of widerange high-power sound, made up of several loudspeaker enclosures, each containing at least one driver or loudspeaker with an emission throat, a duct with parallel or inclined walls between the emission throat of the driver or loudspeaker and a diffraction slot, and a wave guide that continues from the diffraction throat onwards, consisting in divergent walls, at least one of which has adjustable inclination, and characterized by the fact that each enclosure element is equipped with mechanical parts on each side, for connecting it to other identical loudspeaker enclosure elements, positioned vertically one above another and horizontally alongside, for variation of the inclination of each enclosure element on the vertical plane and regulation of the wave guide aperture on the horizontal plan.

2. System according to claim 1, in which said loudspeaker enclosure elements are single enclosures.

3. System according to claim 2, in which each of the said single loudspeaker enclosure elements is contained in a box and the box of each enclosure is connectable vertically and horizontally with the boxes of the adjacent enclosures above and alongside.

4. System according to claim 1, in which said loudspeaker enclosure elements are pre-assembled in multiples, one above the other.

5. System according to claim 4, in which said multiple loudspeaker enclosure elements are all contained in a single box that is connectable vertically and horizontally with the boxes of the adjacent loudspeaker enclosures above and alongside.

6. System according to claim 3, in which said box is raked from front to rear in both height and width, and in which the inclination of each loudspeaker enclosure element on a vertical plane and the variation of the aperture of the wave guide on a horizontal plane is independently adjusted symmetrically or asymmetrically for each loudspeaker enclosure element.

7. System according to claim 1, in which in each loudspeaker enclosure element the wave guide is defined by two first walls that can be angularly positioned around the respective vertical hinge axes independently of each other, symmetrically or asymmetrically.

8. System according to claim 1, in each loudspeaker enclosure element, the wave guide is defined by two first walls that can be angularly positioned around the respective vertical hinge axes independently of each other, symmetrically or asymmetrically.

9. System according to claim 1, in which each loudspeaker enclosure element is also characterized by the inclusion of a first laser emitter generating a light beam from the enclosure's acoustic centre (or sound emission axis), and other laser emitters applied to the walls of the wave guide to show their aperture angle and give clearly, real-time indication of the enclosure's vertical and horizontal solid sound coverage angle.
